(19) United States
(12) Patent Application Publication
(10) Pub. No.: US 2020/0356865 A1
(43) Pub. Date: Nov. 12, 2020

(54) SYSTEM AND METHOD FOR DECISION-MAKING USING A WEIGHTED COMPARISON

(71) Applicant: Thomas D'Auria, Wood-Ridge, NJ (US)

(72) Inventor: Thomas D'Auria, Wood-Ridge, NJ (US)

(21) Appl. No.: 16/655,698

(22) Filed: Oct. 17, 2019

Related U.S. Application Data
(60) Provisional application No. 62/846,617, filed on May 11, 2019.

(51) Int. Cl. G06N 5/00; G06N 20/00; G06Q 10/06

(52) U.S. Cl. CPC G06N 5/00; G06Q 10/06393; G06N 20/00

(57) ABSTRACT

A system is disclosed. The system has a weighted comparison module, comprising computer-executable code stored in non-volatile memory, a processor, and a user device. The weighted comparison module, processor, and user device are configured to receive data of at least one decision-making goal parameter via the user device, determine a plurality of decision-making factors, determine a weight for each of the plurality of decision-making factors, continuously receive data affecting decision-making, determine at least one relationship between an increase or a decrease of a value of the at least one decision-making goal parameter and the plurality of decision-making factors based on iteratively modifying the weights for each of the plurality of decision-making factors and analyzing the continuously-received data, and optimize the value of the at least one decision-making goal parameter by iteratively modifying the weights for each of the plurality of decision-making factors based on the at least one relationship.

### RELATED APPLICATIONS

This application claims the benefit of the following provisional application: 62/846,617 filed May 11, 2019, the entire disclosure of which is incorporated herein by reference.

### TECHNICAL FIELD

The present disclosure generally relates to a system and method for decision-making, and more particularly to a system and method for decision-making using a weighted comparison.

### BACKGROUND

Conventional techniques exist for facilitating difficult decision-making for personal and business applications. However, these conventional techniques often lack an efficient and effective way to adjust a level of importance of factors used in such decision-making.

For example, conventional techniques include using surveys and similar tools to facilitate difficult decision-making. These conventional surveys and similar tools do not include an effective way to efficiently adjust a level of importance of one or more factors considered in difficult decision-making processes.

The exemplary disclosed system, apparatus, and method are directed to overcoming one or more of the shortcomings set forth above and/or other deficiencies in existing technology.

### SUMMARY OF THE DISCLOSURE

In one exemplary aspect, the present disclosure is directed to a system. The system includes a weighted comparison module, comprising computer-executable code stored in non-volatile memory, a processor, and a user device. The weighted comparison module, the processor, and the user device may be configured to receive data of at least one decision-making goal parameter via the user device, determine a plurality of decision-making factors, determine a weight for each of the plurality of decision-making factors, continuously receive data affecting decision-making, determine at least one relationship between an increase or a decrease of a value of the at least one decision-making goal parameter and the plurality of decision-making factors based on iteratively modifying the weights for each of the plurality of decision-making factors and analyzing the continuously-received data, and optimize the value of the at least one decision-making goal parameter by iteratively modifying the weights for each of the plurality of decision-making factors based on the at least one relationship between the increase and the decrease of the value of the at least one decision-making goal parameter and the plurality of decision-making factors.

In another aspect, the present disclosure is directed to a method. The method includes inputting data to a weighted comparison module of at least one decision-making goal parameter via a user device, determining a plurality of decision-making factors, determining a weight for each of the plurality of decision-making factors, continuously receiving data affecting decision-making, determining at least one relationship between an increase or a decrease of a value of the at least one decision-making goal parameter and the plurality of decision-making factors based on iteratively modifying the weights for each of the plurality of decision-making factors and analyzing the continuously-received data, and optimizing the value of the at least one decision-making goal parameter by iteratively modifying the weights for each of the plurality of decision-making factors based on the at least one relationship between the increase and the decrease of the value of the at least one decision-making goal parameter and the plurality of decision-making factors.

### BRIEF DESCRIPTION OF THE DRAWINGS

FIG. 1 illustrates an exemplary disclosed system of at least some exemplary embodiments of the present disclosure;

FIG. 2 illustrates an exemplary disclosed system of at least some exemplary embodiments of the present disclosure;

FIG. 3 illustrates an exemplary disclosed system of at least some exemplary embodiments of the present disclosure;

FIG. 4 illustrates an exemplary disclosed system of at least some exemplary embodiments of the present disclosure;

FIG. 5 illustrates an exemplary process of at least some exemplary embodiments of the present disclosure;

FIG. 6 provides a schematic illustration of an exemplary process of at least some exemplary embodiments of the present disclosure;

FIG. 7 provides a schematic illustration of an exemplary process of at least some exemplary embodiments of the present disclosure;

FIG. 8 is a schematic illustration of an exemplary computing device, in accordance with at least some exemplary embodiments of the present disclosure; and

FIG. 9 is a schematic illustration of an exemplary network, in accordance with at least some exemplary embodiments of the present disclosure.

### DETAILED DESCRIPTION AND INDUSTRIAL APPLICABILITY

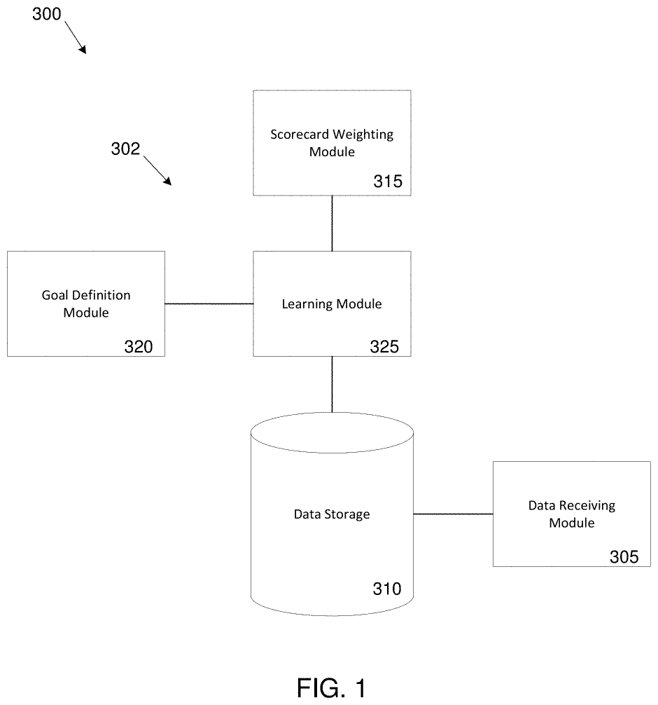

FIG. 1 illustrates an exemplary system 300 for decision-making using a weighted comparison. System 300 may include a weighted comparison module 302 having a data receiving module 305, a data storage 310, a scorecard weighting module 315, a goal definition module 320, and a learning module 325. Data receiving module 305 may provide data to be stored in data storage 310. Learning module 325 may communicate with data storage 310, scorecard weighting module 315, and goal definition module 320 to operate as described herein.

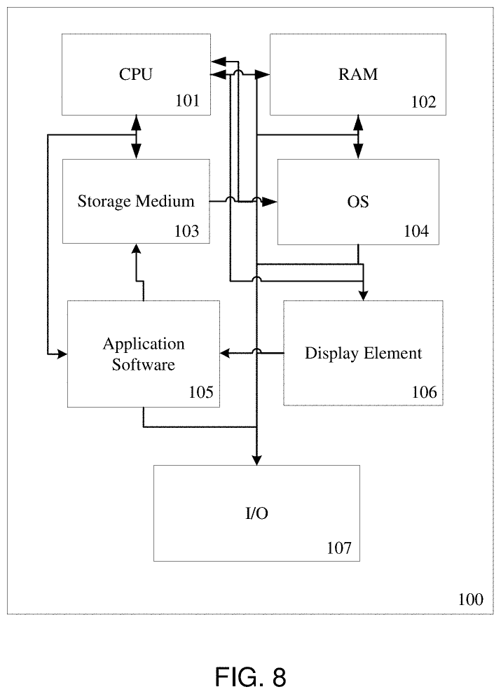

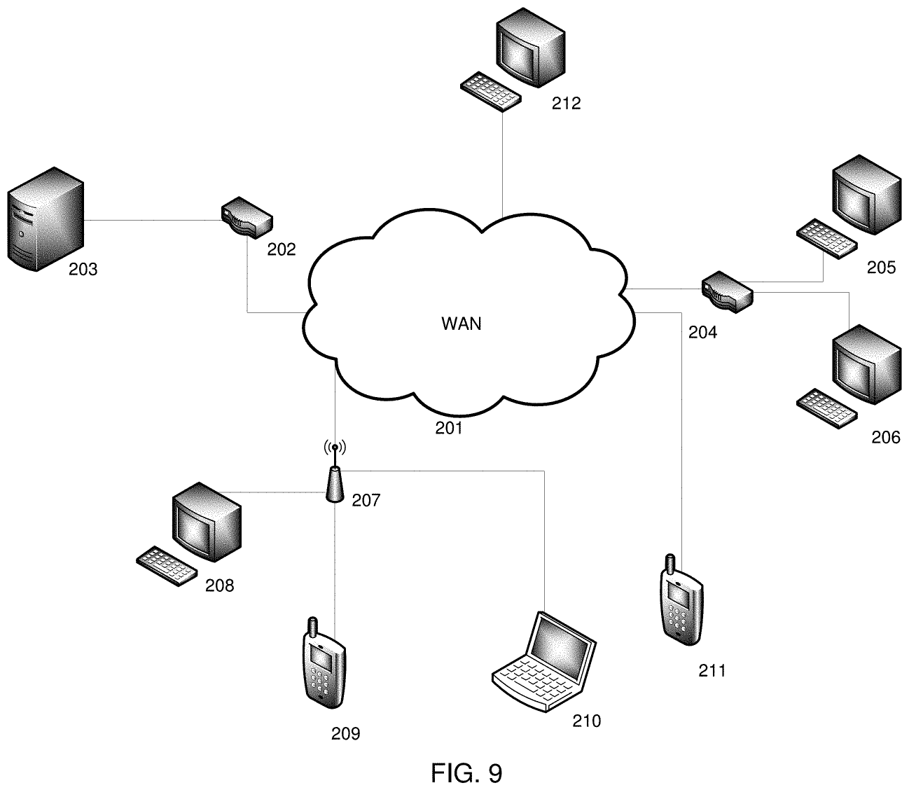

As illustrated in FIG. 1, data receiving module 305, data storage 310, scorecard weighting module 315, goal definition module 320, and learning module 325 may include components similar to the exemplary computing device and network components described below regarding FIGS. 8 and 9. For example, data receiving module 305, scorecard weighting module 315, goal definition module 320, and learning module 325 may include computer-executable code stored in non-volatile memory and a processor for processing data processed, stored, and transferred by system 300. Data receiving module 305, scorecard weighting module 315, goal definition module 320, and/or learning module 325 may be separate modules or integrated with one or more other modules and may be partially or substantially entirely integrated into any component (e.g., or combination of components) of system 300. For example, all of the exemplary disclosed modules may be integrated into weighted comparison module 302. Some or all of the exemplary disclosed modules may be internet-based (e.g., cloud-based) or integrated into user devices such as those described herein.

Data receiving module 305 may receive and transfer any suitable data for use by system 300. Data receiving module 305 may communicate or be integrated with any suitable communication device having any suitable components (e.g., transceivers, wire data transfer components, wireless data transfer components, Bluetooth, Wi-Fi, and/or any suitable communication components for communications such as described herein). Data receiving module 305 may receive and/or transfer data from any suitable data source such as local data sources, cloud-based data sources, and/or any other suitable data sources. Data receiving module 305 may receive and transfer data continuously or periodically over any desired period of time (e.g., days, weeks, months, or years).

Data receiving module 305 may receive and transfer data regarding job applications or interviews such as from databases external to system 300, e.g., recruiting databases, internet-based job application websites and/or aggregators, discussion boards, social media, data transfer directly from job applicants and interviewers, and/or any other suitable job application data source. Data receiving module 305 may receive and/or transfer data from any suitable data source measuring an effectiveness of employee performance or hiring efforts such as internal enterprise computing systems (e.g., company data sources), government data, trade association data, consultant data, white papers, internet review sites (e.g., job or organization review sites), and/or any other suitable data source.

Data receiving module 305 may receive and transfer data regarding product development or performance (e.g., or geographic or other markets) such as from internal enterprise computing systems (e.g., company data sources) and databases external to system 300, e.g., consumer review websites, consumer survey, internet-based product review websites and/or aggregators, discussion boards, social media, data transfer directly from customers or third parties, and/or any other suitable product development or performance data source. Data receiving module 305 may receive and/or transfer data from any suitable data source measuring an effectiveness of new product development or performance such as internal enterprise computing systems (e.g., company data sources), government data, trade association data, customer and consumer surveys, consultant data, white papers, internet review sites (e.g., consumer discussion sites), and/or any other suitable data source. Data receiving module 305 may similarly receive and transfer data regarding major purchases that may be made by individuals or business associations such as cars, trucks, boats and other watercraft, aircraft, real estate (e.g., residential, commercial, and industrial), and financial products such as mortgages and other financial products.

Data receiving module 305 may receive and transfer data regarding company performance such as, for example, from stock market data, financial analyst data, financial media (e.g., websites, newspapers, magazine, and/or other scanned data), internet discussion boards, trade organization websites and data sources, company websites, government websites, bulletins, and reports, and/or any other suitable data source. Data receiving module 305 may also directly communicate with company or enterprise data sources or receive data from third parties (e.g., individuals, companies, or other entities). Data receiving module 305 may similarly receive and transfer data regarding colleges, universities, technical schools, large event (e.g., wedding or reunion) venues, or any other desired institution, company, or vendor.

Data receiving module 305 may receive and transfer data regarding geographic areas (e.g., neighborhoods, towns, cities, metropolitan areas) such as from government sources, e.g., websites and reports, internet discussion boards, social media, real estate organizations, business associations, or any other data source providing information regarding a geographic area.

Data receiving module 305 may receive and transfer data from any suitable data source that may be used in weighting factors in decision-making and/or evaluating results or effectiveness of decision-making such as internet sites (e.g., news media sites, trade media sites, podcasts, social media, crowd-sourced sites, aggregators, review sites, discussion boards, government and official sites, search engine results, and/or any other web-based information), recorded data from radio and television, proprietary data that may be purchased (e.g., from consulting firms), data provided by or obtained directly from third parties, and/or any other suitable data source.

Data receiving module 305 may exchange or transfer the exemplary disclosed data to data storage 310 so that data storage 310 may store the data for use by system 300. Data storage 310 may be any suitable data storage such as disclosed herein (e.g., regarding FIGS. 8 and 9).

Scorecard weighting module 315 may assign and adjust a weight to each of a plurality of factors used in a decision-making process as described for example herein. Scorecard weighting module 315 may assign or adjust weightings used in tools such as scorecards, surveys, and any other suitable decision-making tool (e.g., computing applications for applying weights to factors used in decision-making processes as described for example herein). Data may be transferred between scorecard weighting module 315 and learning module 325 to update the weights of the plurality of factors as described for example herein. System 300 (e.g., learning module 325) may automatically update the weights of the plurality of factors of scorecard weighting module 315 as described for example herein. Also, a user may also update the weights of scorecard weighting module 315 by providing input via a user device such as described herein.

Goal definition module 320 may provide one or more parameters that may be used by system 300 (e.g., learning module 325) for updating the weights of the plurality of factors of scorecard weighting module 315. The exemplary parameters may be input by a user, determined based on an operation of system 300 for example as described herein, and/or provided from an exemplary data source that may be external from system 300.

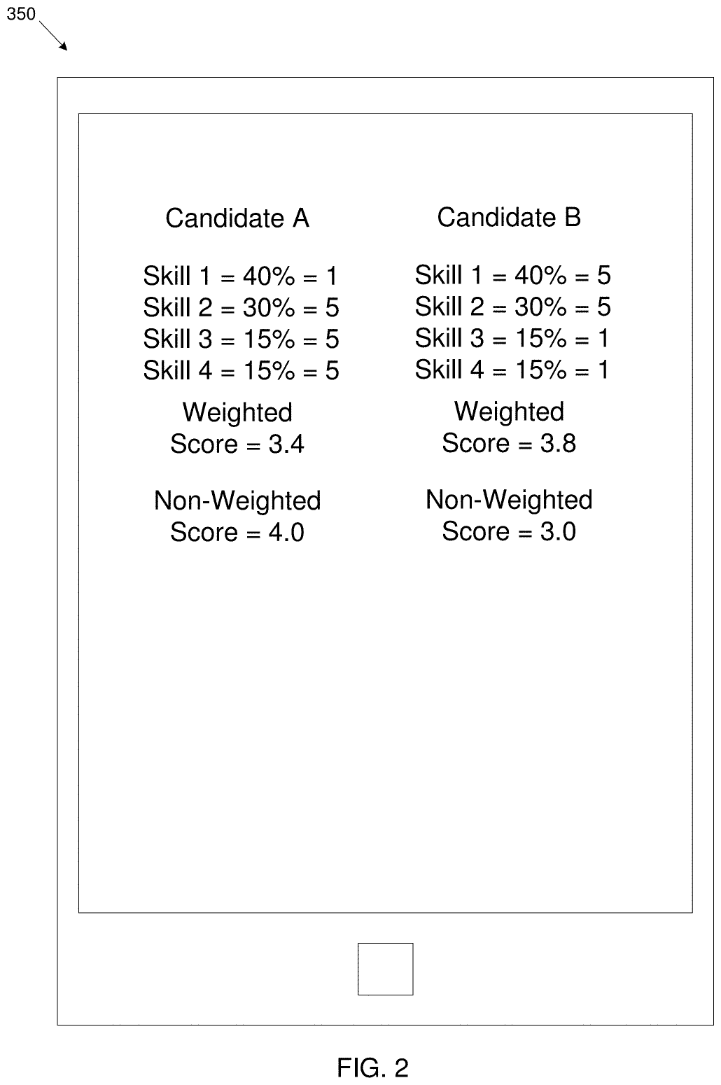

FIGS. 2-4 illustrate an exemplary embodiment of the exemplary disclosed system and method that may be used for example in comparing job applicants. FIGS. 2-4 illustrate one of many possible applications of the present disclosure.

Input and output regarding the exemplary embodiment of FIGS. 2-4 may be provided via any suitable user device or technique such as, for example, a user device 350. User device 350 may be any suitable user device for receiving input and/or providing output (e.g., raw data or other desired information) to a user. User device 350 may be, for example, a touchscreen device (e.g., of a smartphone, a tablet, a smartboard, and/or any suitable computer device), a computer keyboard and monitor (e.g., desktop or laptop), an audio-based device for entering input and/or receiving output via sound, a tactile-based device for entering input and receiving output based on touch or feel, a dedicated user device or interface designed to work specifically with other components of system 300, and/or any other suitable user device or interface. For example, user device 350 may include a touchscreen device of a smartphone or handheld tablet. For example, user device 350 may include a display that may include a graphical user interface to facilitate entry of input by a user and/or receiving output. System 300 may provide notifications to a user via output transmitted to user device 350.

FIG. 2 illustrates two candidates (e.g., Candidate A and Candidate B) being compared based on their respective proficiency levels for a plurality (e.g., four) skills using a scale of between 1 and 5. An interviewer may rate both users based on their proficiency level for each skill. A total weighted and unweighted score may be displayed. For example as illustrated in FIG. 2, candidates A and B may be evaluated for 4 skills that are each weighted (e.g., skill 1 may be weighted at 40%, skill 2 may be weighted at 30%, skill 3 may be weighted at 15%, and skill 4 may be weighted at 15%). The weighted scores (e.g., for candidate “A” the weighted score may be 0.4*1+0.3*5+0.15*5+0.15*5=3.4 and the unweighted score may be 0.25*1+0.25*5+0.25*5+0.25*5=4.0; the weighted score of 3.8 and the unweighted score of 3.0 for candidate “B” may be similarly calculated).

As another example involving a two factor decision process in which the first factor is weighted at 80% and receives a rating of 5, and the second factor is weighted at 20% and receives a rating of 1, the weighted average may be 4.2 (0.8*5+0.2*1=4.2) out of 5 or 84%, and the unweighted average may be 3.0 (0.5*5+0.5*1=3.0). Accordingly, without the weighted system reflecting the relative importance between factors, the user would see an average of 3.0 out of 5 using the unweighted system, which may not provide accurate results.

The exemplary values described above are expressed as rounded numbers for the sake of clarity. The factor weights may be calculated to any desired degree of precision (any desired decimal place).

As illustrated in FIG. 2, candidate “A” may have a higher unweighted score than candidate “B” while having a lower weighted score than candidate “B.” Adjusting the weights may change the overall weighted score. By reflecting the relative importance of some factors compared to other factors, the weighted scores may provide for improved accuracy and more reliable decision-making relative to the unweighted scores.

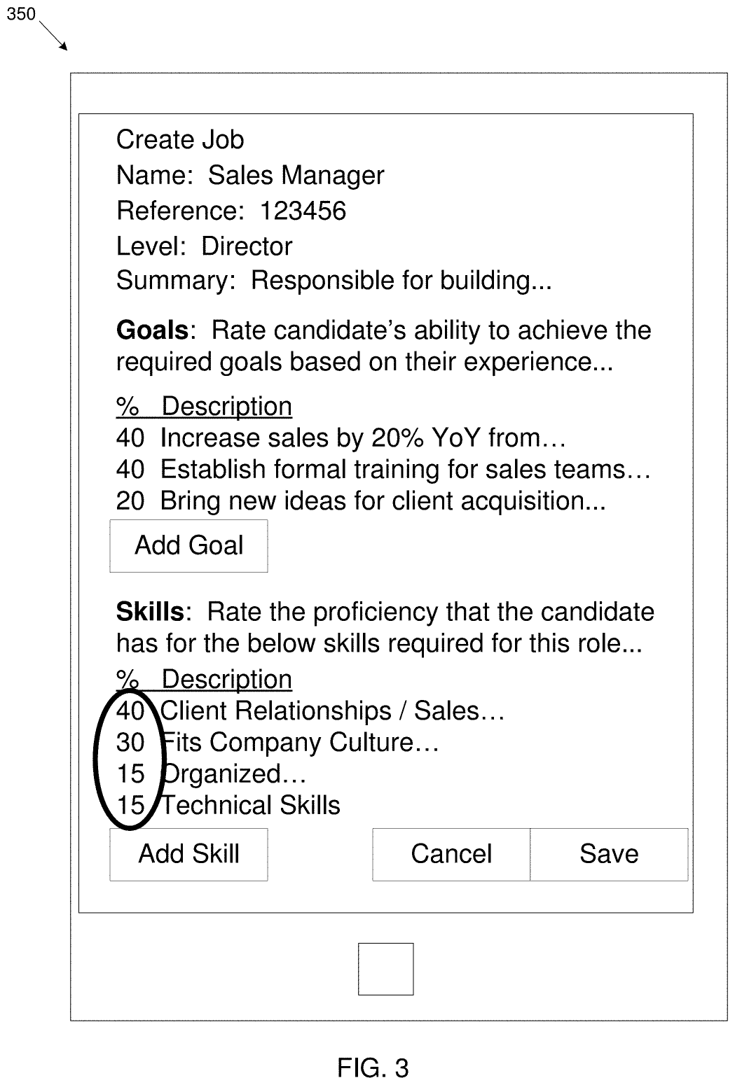

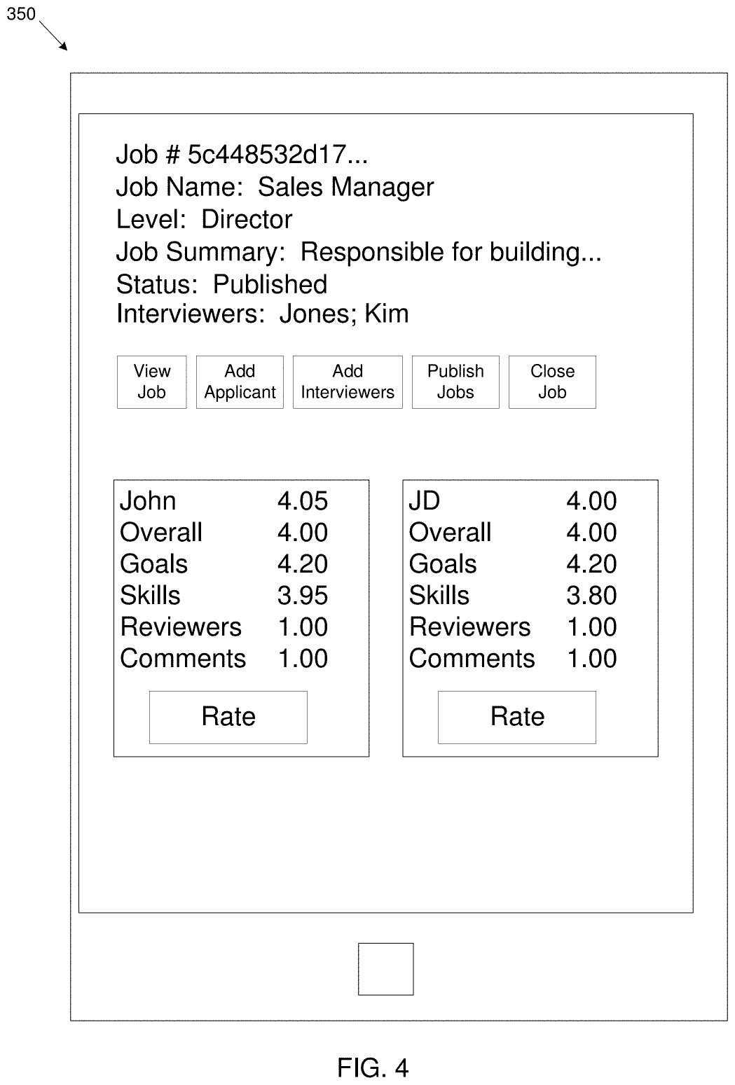

FIGS. 3 and 4 illustrate how another exemplary embodiment of system 300 may be applied using a weighted scorecard for interviewing different candidates for an open job at a company. FIG. 3 illustrates an example of setting up a scorecard for use (e.g., a plurality of weighted factors are shown as circled). FIG. 4 illustrates compiling of data after the scorecard has been filled out.

In another exemplary embodiment, weighting of factors affecting a decision-making process may be adjusted by a user (e.g., or automatically by system 300). This adjustment may be performed at a beginning (e.g., on the front end) of a decision-making process by a direct percentage allocation, by using qualitative factor weights (e.g., “critical,” “important,” or “nice to have”), or by other allocation methods. The allocation (e.g., percentage or qualitative) may be determined and maintained in data storage 310 that may be a backend database). System 300 may automatically calculate and/or adjust the factor weights to add up to 100%. For example, direct percentage factors such as 10%, 20%, 30% or any other desired percentage and/or qualitative factor weights such as “critical,” “important,” “nice to have” may be applied as weights to a scorecard.

The exemplary disclosed system may adjust a level of importance of weights applied to factors, questions, and other data fields in a decision-making process (e.g., and/or may allow users to adjust the weightings). The exemplary disclosed system may allow users to adjust the weights of different data fields to provide results to users in a more accurate way (e.g., to prioritize criteria based on the factors chosen).

The exemplary disclosed system and method may be used in any suitable application for decision-making such as difficult decision-making processes. For example, the exemplary disclosed system and method may be used in any suitable personal and/or business or enterprise applications involving decision-making. The exemplary disclosed system and method may be used in business or enterprise applications such as comparing a plurality of applicants or candidates for a job (e.g., interviewing decision-making) or determining a new product and/or market to pursue (e.g., business and product development decision-making processes). The exemplary disclosed system and method may be used in personal decision-making such as comparing and selecting schools (e.g., colleges and universities) to attend, selecting a wedding venue, deciding between job offers, selecting a house to purchase or rent, selecting a location to which to move, or buying a car or making any other desired relatively large purchase (e.g., a boat, jet-ski, or vacation home).

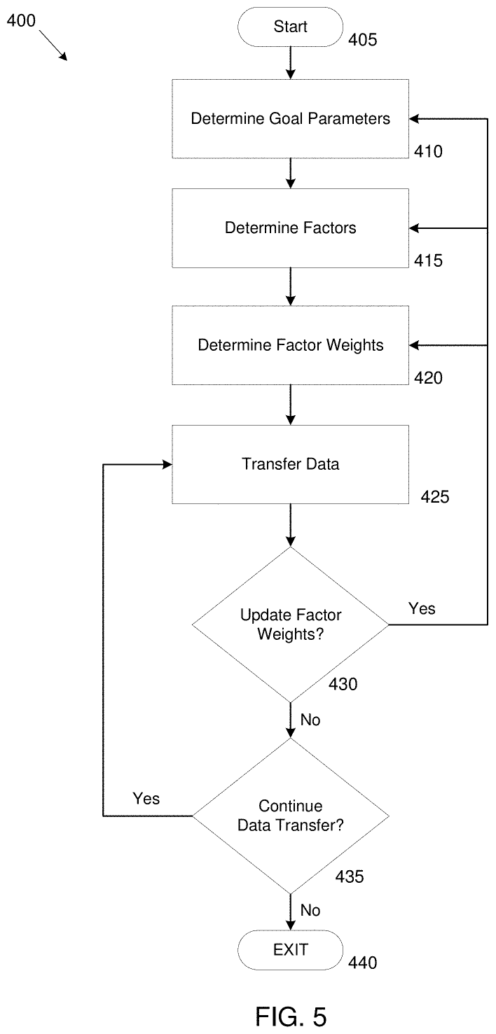

FIG. 5 illustrates an exemplary operation of the exemplary disclosed system 300. Process 400 may be a decision-making process for optimizing the selection of a course of action for any suitable decision-making such as difficult decision-making. The decision-making may involve any desired activity or action such as for example the exemplary activities described above. In at least some exemplary embodiments, process 400 may be an algorithm that provides a series of steps (e.g., as described herein) for system 300 to take for learning from a database while making recommendations. Process 400 begins at step 405.

At step 410, system 300 (e.g., goal definition module 320) may determine one or more goal parameters. For example, a user may use a user device (e.g., user device 350) to input one or more goal parameters to goal definition module 320. Also for example, goal parameters may be determined based on one or more predetermined algorithms of system 300 or be provided from an exemplary data source that may be external from system 300. The one or more goal parameters may be any suitable value or set of values that define a threshold or value defining success in an activity that process 400 is operating to support. For example, if process 400 is operating to optimize job applicant selection (e.g., choose the applicant who best supports the goal parameters), the goal parameters may include length of employment (e.g., a number of years), performance ratings (e.g., a numerical rating given by human resources), company profit (e.g., a currency amount per year) attributed to employee, or any other suitable parameter reflecting one or more desired goals. Also for example, if process 400 is operating to optimize college or university selection (e.g., choose the school that best supports the goal parameters), the goal parameters may include graduation rate (e.g., a percentage value), employment rate after graduation (e.g., a percentage value), salary rates over time, or any other suitable parameter reflecting one or more desired goals. Also for example, if process 400 is operating to optimize a car purchase (e.g., choose the car that best supports the goal parameters), the goal parameters may include amount or other measure of money spent on maintenance during operation, amount of miles traveled per total cost, resale value, or any other suitable parameter reflecting one or more desired goals. The one or more goal parameters may be any suitable threshold, value, or measure associated with a desired outcome to be attained based on the exemplary disclosed decision-making process. For example, depending on the exemplary goal parameter, an increase (e.g., or a decrease) in the value of the goal parameter may indicate improved performance (e.g., more effectiveness in achieving desired goals).

At step 415, system 300 may determine a plurality of factors for decision-making. For example, a user may use a user device (e.g., user device 350) to input one or more factors to system 300. Also for example, factors may be determined based on one or more predetermined algorithms of system 300 or be provided from an exemplary data source that may be external from system 300. The plurality of factors may be any suitable factors that may impact or determine a decision to be made during a decision-making process. For example, if process 400 is operating to optimize job applicant selection, the factors (e.g., as quantitatively and/or qualitatively rated by an interviewer) may include client relationship and salesmanship skills, ability to fit into company culture, organizational ability, technical skills, or any other suitable factor that may impact or affect decision-making. Also for example, if process 400 is operating to optimize college or university selection, the factors may include available desired majors, condition of facilities, location, cost, professor ratings, alumni support, statistics of sports programs, available extracurricular activities, or any other suitable factor that may impact or affect decision-making. Also for example, if process 400 is operating to optimize a car purchase, the factors may include cost, available features, accessories and add-ons, horsepower, type of drive (e.g., 2-wheel or 4-wheel drive), type of powertrain (e.g., gasoline engine, diesel engine, hybrid, or electric), and/or any other suitable factor that may impact or affect decision-making. The plurality of factors may be any suitable factor that may affect a decision that will ultimately be made regarding an action, activity, life choice, purchase, or other significant decision.

At step 420, system 300 may determine factor weights for the plurality of factors established at step 415. For example, a user may use a user device (e.g., user device 350) to input weights to scorecard weighting module 315 for the plurality of factors established at step 415. System 300 may automatically determine initial weights and/or update the weights of the plurality of factors of scorecard weighting module 315 as described below. Also for example, initial factor weights may be determined based on one or more predetermined algorithms of system 300 or be provided from an exemplary data source that may be external from system 300.

At step 425, system 300 may receive and/or transfer data such as the exemplary data described above. Data receiving module 305 may transfer data to data storage 310 for use during an operation of system 300. Data may also be received and/or transferred by system 300 and/or transferred between components of system 300 during any step of process 400.

At step 430 (e.g., and at step 425), system 300 (e.g., learning module 325) may determine whether to update factor weights established at step 420. System 300 (e.g., learning module 325) may also determine whether to add additional factors, modify factors, and/or delete factors established at step 415. System 300 (e.g., learning module 325) may also determine whether to add additional goal parameters, modify goal parameters, and/or delete goal parameters established at step 410.

System 300 (e.g., learning module 325) may utilize collected data to prepare and submit datasets and variables to cloud computing clusters and/or other analytical tools (e.g., predictive analytical tools) which may analyze such data using artificial intelligence neural networks. The exemplary disclosed system may for example include cloud computing clusters performing predictive analysis. For example, the exemplary disclosed system may utilize neural network-based artificial intelligence to predictively assess risk. For example, the exemplary neural network may include a plurality of input nodes that may be interconnected and/or networked with a plurality of additional and/or other processing nodes to determine a predicted result (e.g., a location as described for example herein).

For example, exemplary artificial intelligence processes of system 300 (e.g., learning module 325) may include filtering and processing datasets, processing to simplify datasets by statistically eliminating irrelevant, invariant or superfluous variables or creating new variables which are an amalgamation of a set of underlying variables, and/or processing for splitting datasets into train, test and validate datasets using at least a stratified sampling technique. For example, the prediction algorithms and approach may include regression models, tree-based approaches, logistic regression, Bayesian methods, deep-learning and neural networks both as a stand-alone and on an ensemble basis, and final prediction may be based on the model/structure which delivers the highest degree of accuracy and stability as judged by implementation against the test and validate datasets. Also for example, exemplary artificial intelligence processes may include processing for training a machine learning model to make predictions based on data collected by the exemplary disclosed sensors.

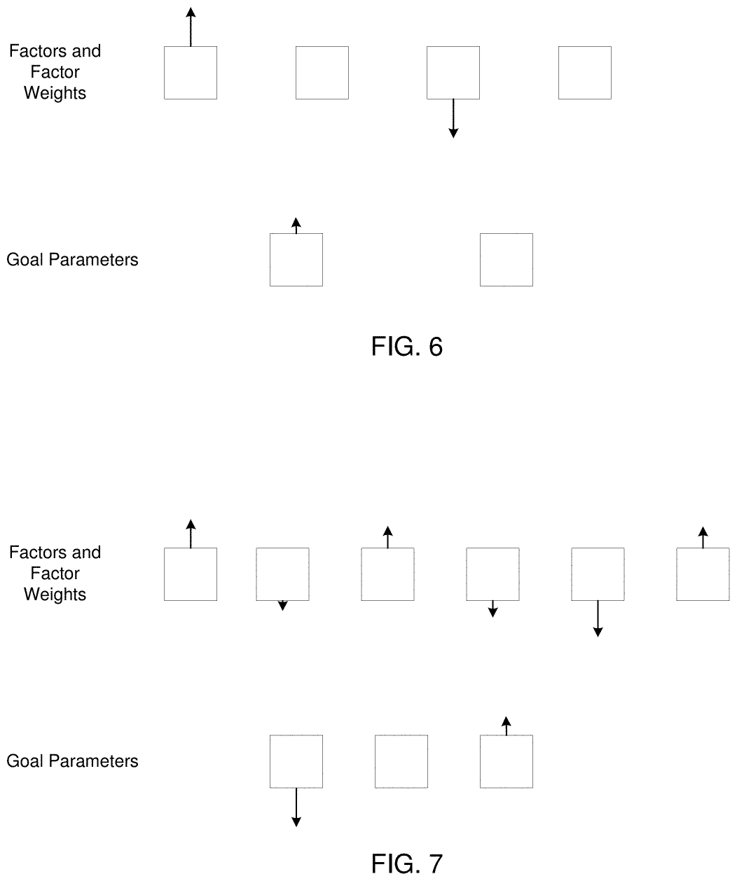

In at least some exemplary embodiments, system 300 (e.g., learning module 325) may utilize artificial intelligence and machine learning processes to analyze data of data storage 310 to determine correlations between factors established at step 415, factor weights established at step 420, and goal parameters established at step 410. For example as illustrated in FIGS. 6 and 7, learning module 325 may analyze data of data storage 310 (for example over time) to determine whether a correlation exists between an increase or decrease in a single factor weight or a combination of factor weights and an increase or decrease in a value of a single goal parameter or values of a combination of goal parameters. For example as schematically illustrated in FIGS. 6 and 7, system 300 (e.g., learning module 325) may analyze data sets based on factors established at step 415 having differing weights established at step 420 over successive iterations of process 400 using any suitable technique such as any suitable correlation coefficient technique (e.g., Spearman rank order correlation or Person's rank correlation), linear and/or non-linear data correlation techniques, or any other suitable data analytical technique. System 300 (e.g., learning module 325) may utilize artificial intelligence and machine learning processes to analyze data over time during any desired number of iterations of process 400 over hours, days, months, or years.

For example based on artificial intelligence and machine learning processes performed at step 430, system 300 may return to step 420 to modify weights of the factors established at step 415 (e.g., or users may directly enter input to modify weights to scorecard weighting module 315). Also for example based on artificial intelligence and machine learning processes performed at step 430, system 300 may return to step 415 to add, modify, or delete factors (e.g., or users may directly enter input to scorecard weighting module 315). Further for example based on artificial intelligence and machine learning processes performed at step 430, system 300 may return to step 410 to add, modify, or delete goal parameters (e.g., or users may directly enter input to goal definition module 320).

System 300 may operate using the steps of process 400 for any desired number of iterations and time duration. System 300 (e.g., learning module 325) may utilize artificial intelligence and machine learning processes through each successive iteration to further analyze and learn correlations and any other suitable relationship between factor weights, factors, and goal parameters over time. System 300 may use the learned relationships to automatically optimize factor weights for desired goal parameters and to automatically adjust and update factor weights in response to changes (e.g., by users) to desired goal parameters.

In at least some exemplary embodiments, system 300 (e.g., learning module 325) may utilize artificial intelligence and machine learning processes to make small and/or gradual changes to factor weights to determine correlations and relationships between the factors, factor weights, and goal parameters without causing significant variations to the performance or activity being optimized by process 400. For example, in the area of job applicants, system 300 (e.g., learning module 325) may adjust the weights of significant skills upward or downward to determine correlations and relationships (e.g., small changes in terms of quantitative measures) without significantly negatively affecting an organization's hiring practices and overall performance.

As an example, system 300 (e.g., learning module 325) may utilize artificial intelligence and machine learning processes to optimize the job applicant decision-making example illustrated in FIGS. 2-4. System 300 may iteratively operate using process 400 as described above to determine the factor weights illustrated in FIGS. 2 and 3. These exemplary factor weights may be optimized to support any desired goal parameter such as, for example, maximum overall organic sales growth. The goal parameters may be changed as desired, for example based on strategic decision-making by users (e.g., board room strategic shifts in business goals) and/or based on artificial intelligence and machine learning processes of system 300 (e.g., learning module 325). For example regarding the job applicant decision-making of FIGS. 2 and 3, an organization being supported by system 300 and process 400 may determine that maximum organic sales growth is no longer a primary goal. For example, maximum sales of select major product lines may replace maximum overall organic sales as the goal parameter (e.g., or each may be a goal parameter). System 300 may proceed to step 410, at which the goal parameters may be changed as desired (e.g., the goal parameter may be changed to maximum sales of select major product lines, for example when a company is making a strategic, “all hands” effort to bet the future of the company on certain products or a new product line to transform the company to align with changes in the marketplace). Changes in goal parameters may also reflect smaller adjustments to the marketplace or to company goals. System 300 may then continue to iteratively proceed through the steps of process 400 to adjust factor weights (e.g., and factors) to increase the value of the revised goal parameter. For example, system 300 (e.g., learning module 325) may utilize artificial intelligence and machine learning processes as described above to determine that increasing the weight of “client relationships” and decreasing the weight of “fits company culture” (e.g., or any other suitable modification) in hiring may increase the value of the revised goal parameter (e.g., increase maximum sales of select major product lines) over time. Goal parameters may be revised at any desired time to align, for example, with an enterprise's or individual's objectives or business plan (e.g., short-term plans or longer term strategic plans). Changing the goal parameters as described above, with system 300 automatically updating factor weights and factors as described above, may thereby allow system 300 and process 400 to support an enterprise's or individual's goals as those goals change over time.

In at least some exemplary embodiments, goal parameters may be similarly weighted and modified as described above regarding the factor weights. For example, a second process that may be similar to process 400 described above may be nested within step 410 to determine optimal goal parameter weights. For example, system 300 (e.g., learning module 325) may utilize artificial intelligence and machine learning processes to optimize both factor weights at step 420 and goal parameter weights of a plurality of goal parameters at step 410 by performing a second process at step 410 that may be similar to process 400, in parallel with (e.g., as part of) process 400.

If system 300 determines that no changes are to be made to the goal parameters, factors, and factor weights at step 430, process 400 may proceed to step 435. At step 435, system 300 may determine whether or not to continue data transfer, based for example on user input or predetermined algorithms (e.g., or artificial intelligence or machine learning operations of system 300). If data transfer is to continue, process 400 may return to step 425. If data transfer is not to continue, process 400 may proceed to step 440, at which process 400 ends.

In at least some exemplary embodiments, the exemplary disclosed system may include a weighted comparison module (e.g., weighted comparison module 302), comprising computer-executable code stored in non-volatile memory, a processor, and a user device (e.g., user device 350). The weighted comparison module, the processor, and the user device may be configured to receive data of at least one decision-making goal parameter via the user device, determine a plurality of decision-making factors, determine a weight for each of the plurality of decision-making factors, continuously receive data affecting decision-making, determine at least one relationship between an increase or a decrease of a value of the at least one decision-making goal parameter and the plurality of decision-making factors based on iteratively modifying the weights for each of the plurality of decision-making factors and analyzing the continuously-received data, and optimize the value of the at least one decision-making goal parameter by iteratively modifying the weights for each of the plurality of decision-making factors based on the at least one relationship between the increase and the decrease of the value of the at least one decision-making goal parameter and the plurality of decision-making factors. The weighted comparison module, the processor, and the user device may be configured to receive data of a second decision-making goal parameter. The weighted comparison module, the processor, and the user device may be configured to stop optimizing the value of the at least one decision-making goal parameter when the data of the second decision-making goal parameter is received. The weighted comparison module, the processor, and the user device may be configured to determine at least one relationship between an increase or a decrease of a value of the second decision-making goal parameter and the plurality of decision-making factors based on iteratively modifying the weights for each of the plurality of decision-making factors and analyzing the continuously-received data. The weighted comparison module, the processor, and the user device may be configured to optimize the value of the second decision-making goal parameter by iteratively modifying the weights for each of the plurality of decision-making factors based on the at least one relationship between the increase and the decrease of the value of the second decision-making goal parameter and the plurality of decision-making factors. The at least one decision-making goal parameter may be replaced by the second decision-making goal parameter based on a business strategy change. The data affecting decision-making may be selected from the group consisting of job applicant data and new product development data. The data affecting decision-making may be selected from the group consisting of college and university data, wedding venue data, job offer data, real estate data, and vehicle purchase data. The weighted comparison module, the processor, and the user device may be configured to modify the plurality of decision-making factors to add at least one factor, change at least one factor, or delete at least one factor. The at least one decision-making goal parameter may include a plurality of decision-making goal parameters, and the weighted comparison module, the processor, and the user device may be configured to determine a goal weight for each of the plurality of decision-making goal parameters. The weighted comparison module, the processor, and the user device may be configured to determine at least one relationship between an increase or a decrease of a value of the plurality of decision-making goal parameters and the plurality of decision-making factors based on iteratively modifying the weights for each of the plurality of decision-making factors and the goal weights for each of the plurality of decision-making goal parameters. The weighted comparison module, the processor, and the user device may be configured to optimize the values of the plurality of decision-making goal parameters by iteratively modifying the weights for each of the plurality of decision-making factors and the goal weights for each of the plurality of decision-making goal parameters based on the at least one relationship between the increase and the decrease of the value of the plurality of decision-making goal parameters and the plurality of decision-making factors.

In at least some exemplary embodiments, the exemplary disclosed method may include inputting data to a weighted comparison module (e.g., weighted comparison module 302) of at least one decision-making goal parameter via a user device (e.g., user device 350), determining a plurality of decision-making factors, determining a weight for each of the plurality of decision-making factors, continuously receiving data affecting decision-making, determining at least one relationship between an increase or a decrease of a value of the at least one decision-making goal parameter and the plurality of decision-making factors based on iteratively modifying the weights for each of the plurality of decision-making factors and analyzing the continuously-received data, and optimizing the value of the at least one decision-making goal parameter by iteratively modifying the weights for each of the plurality of decision-making factors based on the at least one relationship between the increase and the decrease of the value of the at least one decision-making goal parameter and the plurality of decision-making factors. The method may further include inputting data to a weighted comparison module of a second decision-making goal parameter via the user device. The method also include stopping optimization of the value of the at least one decision-making goal parameter when the data of the second decision-making goal parameter is received. The method may additionally include determining at least one relationship between an increase or a decrease of a value of the second decision-making goal parameter and the plurality of decision-making factors based on iteratively modifying the weights for each of the plurality of decision-making factors and analyzing the continuously-received data. The method may also include optimizing the value of the second decision-making goal parameter by iteratively modifying the weights for each of the plurality of decision-making factors based on the at least one relationship between the increase and the decrease of the value of the second decision-making goal parameter and the plurality of decision-making factors.

In at least some exemplary embodiments, the exemplary disclosed system may include a weighted comparison module (e.g., weighted comparison module), comprising computer-executable code stored in non-volatile memory, a processor, and a user device (e.g., user device 350). The weighted comparison module, the processor, and the user device may be configured to receive data of a plurality of decision-making goal parameters via the user device, determine a plurality of decision-making factors, determine a weight for each of the plurality of decision-making factors, continuously receive data affecting decision-making, determine at least one relationship between an increase or a decrease of a value of the plurality of decision-making goal parameters and the plurality of decision-making factors based on iteratively modifying the weights for each of the plurality of decision-making factors and the goal weights for each of the plurality of decision-making goal parameters, and optimize the values of the plurality of decision-making goal parameters by iteratively modifying the weights for each of the plurality of decision-making factors and the goal weights for each of the plurality of decision-making goal parameters based on the at least one relationship between the increase and the decrease of the value of the plurality of decision-making goal parameters and the plurality of decision-making factors. The weighted comparison module, the processor, and the user device may be configured to receive data of a second plurality of decision-making goal parameters. The weighted comparison module, the processor, and the user device may be configured to stop optimizing the value of the plurality of decision-making goal parameters when the data of the second plurality of decision-making goal parameters is received.

The exemplary disclosed system and method may provide an efficient and effective technique for efficiently and effectively making difficult decisions. For example, the exemplary disclosed system and method may provide users with an efficient and effective technique to adjust a weight factors used in a decision-making process. For example, the exemplary disclosed system and method may allow for insightful comparisons between factors involved in decision-making and may result in effective decision making (e.g., improved decision-making).

An illustrative representation of a computing device appropriate for use with embodiments of the system of the present disclosure is shown in FIG. 8. The computing device 100 can generally be comprised of a Central Processing Unit (CPU, 101), optional further processing units including a graphics processing unit (GPU), a Random Access Memory (RAM, 102), a mother board 103, or alternatively/additionally a storage medium (e.g., hard disk drive, solid state drive, flash memory, cloud storage), an operating system (OS, 104), one or more application software 105, a display element 106, and one or more input/output devices/means 107, including one or more communication interfaces (e.g., RS232, Ethernet, Wi-Fi, Bluetooth, USB). Useful examples include, but are not limited to, personal computers, smart phones, laptops, mobile computing devices, tablet PCs, touch boards, and servers. Multiple computing devices can be operably linked to form a computer network in a manner as to distribute and share one or more resources, such as clustered computing devices and server banks/farms.

Various examples of such general-purpose multi-unit computer networks suitable for embodiments of the disclosure, their typical configuration and many standardized communication links are well known to one skilled in the art, as explained in more detail and illustrated by FIG. 9, which is discussed herein-below.

According to an exemplary embodiment of the present disclosure, data may be transferred to the system, stored by the system and/or transferred by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present disclosure are contemplated for use with any configuration.

In general, the system and methods provided herein may be employed by a user of a computing device whether connected to a network or not. Similarly, some steps of the methods provided herein may be performed by components and modules of the system whether connected or not. While such components/modules are offline, and the data they generated will then be transmitted to the relevant other parts of the system once the offline component/module comes again online with the rest of the network (or a relevant part thereof). According to an embodiment of the present disclosure, some of the applications of the present disclosure may not be accessible when not connected to a network, however a user or a module/component of the system itself may be able to compose data offline from the remainder of the system that will be consumed by the system or its other components when the user/offline system component or module is later connected to the system network.

Referring to FIG. 9, a schematic overview of a system in accordance with an embodiment of the present disclosure is shown. The system is comprised of one or more application servers 203 for electronically storing information used by the system. Applications in the server 203 may retrieve and manipulate information in storage devices and exchange information through a WAN 201 (e.g., the Internet). Applications in server 203 may also be used to manipulate information stored remotely and process and analyze data stored remotely across a WAN 201 (e.g., the Internet).

According to an exemplary embodiment, as shown in FIG. 9, exchange of information through the WAN 201 or other network may occur through one or more high speed connections. In some cases, high speed connections may be over-the-air (OTA), passed through networked systems, directly connected to one or more WANs 201 or directed through one or more routers 202. Router(s) 202 are completely optional and other embodiments in accordance with the present disclosure may or may not utilize one or more routers 202. One of ordinary skill in the art would appreciate that there are numerous ways server 203 may connect to WAN 201 for the exchange of information, and embodiments of the present disclosure are contemplated for use with any method for connecting to networks for the purpose of exchanging information. Further, while this application refers to high speed connections, embodiments of the present disclosure may be utilized with connections of any speed.

Components or modules of the system may connect to server 203 via WAN 201 or other network in numerous ways. For instance, a component or module may connect to the system i) through a computing device 212 directly connected to the WAN 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GSM, 3G, 4G) to the WAN 201. One of ordinary skill in the art will appreciate that there are numerous ways that a component or module may connect to server 203 via WAN 201 or other network, and embodiments of the present disclosure are contemplated for use with any method for connecting to server 203 via WAN 201 or other network. Furthermore, server 203 could be comprised of a personal computing device, such as a smartphone, acting as a host for other computing devices to connect to.

The communications means of the system may be any means for communicating data, including text, binary data, image and video, over one or more networks or to one or more peripheral devices attached to the system, or to a system module or component. Appropriate communications means may include, but are not limited to, wireless connections, wired connections, cellular connections, data port connections, Bluetooth® connections, near field communications (NFC) connections, or any combination thereof. One of ordinary skill in the art will appreciate that there are numerous communications means that may be utilized with embodiments of the present disclosure, and embodiments of the present disclosure are contemplated for use with any communications means.

Traditionally, a computer program includes a finite sequence of computational instructions or program instructions. It will be appreciated that a programmable apparatus or computing device can receive such a computer program and, by processing the computational instructions thereof, produce a technical effect.

A programmable apparatus or computing device includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computing device can include any and all suitable combinations of at least one general purpose computer, special-purpose computer, programmable data processing apparatus, processor, processor architecture, and so on. It will be understood that a computing device can include a computer-readable storage medium and that this medium may be internal or external, removable and replaceable, or fixed. It will also be understood that a computing device can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the disclosure as claimed herein could include an optical computer, quantum computer, analog computer, or the like.

Regardless of the type of computer program or computing device involved, a computer program can be loaded onto a computing device to produce a particular machine that can perform any and all of the depicted functions. This particular machine (or networked configuration thereof) provides a technique for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Illustrative examples of the computer readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A data store may be comprised of one or more of a database, file storage system, relational data storage system or any other data system or structure configured to store data. The data store may be a relational database, working in conjunction with a relational database management system (RDBMS) for receiving, processing and storing data. A data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software components or modules, or as components or modules that employ external routines, code, services, and so forth, or any combination of these. All such implementations are within the scope of the present disclosure. In view of the foregoing, it will be appreciated that elements of the block diagrams and flowchart illustrations support combinations of means for performing the specified functions, combinations of steps for performing the specified functions, program instruction technique for performing the specified functions, and so on.

It will be appreciated that computer program instructions may include computer executable code. A variety of languages for expressing computer program instructions are possible, including without limitation Kotlin, Swift, C#, PHP, C, C++, Assembler, Java, HTML, JavaScript, CSS, and so on. Such languages may include assembly languages, hardware description languages, database programming languages, functional programming languages, imperative programming languages, and so on. In some embodiments, computer program instructions can be stored, compiled, or interpreted to run on a computing device, a programmable data processing apparatus, a heterogeneous combination of processors or processor architectures, and so on. Without limitation, embodiments of the system as described herein can take the form of mobile applications, firmware for monitoring devices, web-based computer software, and so on, which includes client/server software, software-as-a-service, peer-to-peer software, or the like.

In some embodiments, a computing device enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computing device can process these threads based on priority or any other order based on instructions provided in the program code.

Unless explicitly stated or otherwise clear from the context, the verbs “process” and “execute” are used interchangeably to indicate execute, process, interpret, compile, assemble, link, load, any and all combinations of the foregoing, or the like. Therefore, embodiments that process computer program instructions, computer-executable code, or the like can suitably act upon the instructions or code in any and all of the ways just described.

The functions and operations presented herein are not inherently related to any particular computing device or other apparatus. Various general-purpose systems may also be used with programs in accordance with the teachings herein, or it may prove convenient to construct more specialized apparatus to perform the required method steps. The required structure for a variety of these systems will be apparent to those of ordinary skill in the art, along with equivalent variations. In addition, embodiments of the disclosure are not described with reference to any particular programming language. It is appreciated that a variety of programming languages may be used to implement the present teachings as described herein, and any references to specific languages are provided for disclosure of enablement and best mode of embodiments of the disclosure. Embodiments of the disclosure are well suited to a wide variety of computer network systems over numerous topologies. Within this field, the configuration and management of large networks include storage devices and computing devices that are communicatively coupled to dissimilar computing and storage devices over a network, such as the Internet, also referred to as “web” or “world wide web”.

Throughout this disclosure and elsewhere, block diagrams and flowchart illustrations depict methods, apparatuses (e.g., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “component”, “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present disclosure are contemplated for use with any language.

It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments.

It will be apparent to those skilled in the art that various modifications and variations can be made to the disclosed system and method. Other embodiments will be apparent to those skilled in the art from consideration of the specification and practice of the disclosed method and apparatus. It is intended that the specification and examples be considered as exemplary only, with a true scope being indicated by the following claims.

What is claimed is:

1. A system, comprising:
a weighted comparison module, comprising computer-executable code stored in non-volatile memory;
a processor; and
a user device;
wherein the weighted comparison module, the processor, and the user device are configured to:
receive data of at least one decision-making goal parameter via the user device;
determine a plurality of decision-making factors;
determine a weight for each of the plurality of decision-making factors;
continuously receive data affecting decision-making;
determine at least one relationship between an increase or a decrease of a value of the at least one decision-making goal parameter and the plurality of decision-making factors based on iteratively modifying the weights for each of the plurality of decision-making factors and analyzing the continuously-received data; and
optimize the value of the at least one decision-making goal parameter by iteratively modifying the weights for each of the plurality of decision-making factors based on the at least one relationship between the increase and the decrease of the value of the at least one decision-making goal parameter and the plurality of decision-making factors.

2. The system of claim 1, wherein the weighted comparison module, the processor, and the user device are configured to receive data of a second decision-making goal parameter.

3. The system of claim 2, wherein the weighted comparison module, the processor, and the user device are configured to stop optimizing the value of the at least one decision-making goal parameter when the data of the second decision-making goal parameter is received.

4. The system of claim 3, wherein the weighted comparison module, the processor, and the user device are configured to determine at least one relationship between an increase or a decrease of a value of the second decision-making goal parameter and the plurality of decision-making factors based on iteratively modifying the weights for each of the plurality of decision-making factors and analyzing the continuously-received data.

5. The system of claim 4, wherein the weighted comparison module, the processor, and the user device are configured to optimize the value of the second decision-making goal parameter by iteratively modifying the weights for each of the plurality of decision-making factors based on the at least one relationship between the increase and the decrease of the value of the second decision-making goal parameter and the plurality of decision-making factors.

6. The system of claim 2, wherein the at least one decision-making goal parameter is replaced by the second decision-making goal parameter based on a business strategy change.

7. The system of claim 1, wherein the data affecting decision-making is selected from the group consisting of job applicant data and new product development data.

8. The system of claim 1, wherein the data affecting decision-making is selected from the group consisting of college and university data, wedding venue data, job offer data, real estate data, and vehicle purchase data.

9. The system of claim 1, wherein the weighted comparison module, the processor, and the user device are configured to modify the plurality of decision-making factors to add at least one factor, change at least one factor, or delete at least one factor.

10. The system of claim 1, wherein the at least one decision-making goal parameter includes a plurality of decision-making goal parameters, and the weighted comparison module, the processor, and the user device are configured to determine a goal weight for each of the plurality of decision-making goal parameters.

11. The system of claim 10, wherein the weighted comparison module, the processor, and the user device are configured to determine at least one relationship between an increase or a decrease of a value of the plurality of decision-making goal parameters and the plurality of decision-making factors based on iteratively modifying the weights for each of the plurality of decision-making factors and the goal weights for each of the plurality of decision-making goal parameters.

12. The system of claim 11, wherein the weighted comparison module, the processor, and the user device are configured to optimize the values of the plurality of decision-making goal parameters by iteratively modifying the weights for each of the plurality of decision-making factors and the goal weights for each of the plurality of decision-making goal parameters based on the at least one relationship between the increase and the decrease of the value of the plurality of decision-making goal parameters and the plurality of decision-making factors.

13. A method, comprising:
inputting data to a weighted comparison module of at least one decision-making goal parameter via a user device;
determining a plurality of decision-making factors;
determining a weight for each of the plurality of decision-making factors;
continuously receiving data affecting decision-making;
determining at least one relationship between an increase or a decrease of a value of the at least one decision-making goal parameter and the plurality of decision-making factors based on iteratively modifying the weights for each of the plurality of decision-making factors and analyzing the continuously-received data; and
optimizing the value of the at least one decision-making goal parameter by iteratively modifying the weights for each of the plurality of decision-making factors based on the at least one relationship between the increase and the decrease of the value of the at least one decision-making goal parameter and the plurality of decision-making factors.

14. The method of claim 13, further comprising inputting data to a weighted comparison module of a second decision-making goal parameter via the user device.

15. The method of claim 14, further comprising stopping optimization of the value of the at least one decision-making goal parameter when the data of the second decision-making goal parameter is received.

16. The method of claim 15, further comprising determining at least one relationship between an increase or a decrease of a value of the second decision-making goal parameter and the plurality of decision-making factors based on iteratively modifying the weights for each of the plurality of decision-making factors and analyzing the continuously-received data.

17. The method of claim 16, further comprising optimizing the value of the second decision-making goal parameter by iteratively modifying the weights for each of the plurality of decision-making factors based on the at least one relationship between the increase and the decrease of the value of the second decision-making goal parameter and the plurality of decision-making factors.

18. A system, comprising:
a weighted comparison module, comprising computer-executable code stored in non-volatile memory;
a processor; and
a user device;
wherein the weighted comparison module, the processor, and the user device are configured to:
receive data of a plurality of decision-making goal parameters via the user device;
determine a plurality of decision-making factors;
determine a weight for each of the plurality of decision-making factors;
continuously receive data affecting decision-making;
determine at least one relationship between an increase or a decrease of a value of the plurality of decision-making goal parameters and the plurality of decision-making factors based on iteratively modifying the weights for each of the plurality of decision-making factors and the goal weights for each of the plurality of decision-making goal parameters; and
optimize the values of the plurality of decision-making goal parameters by iteratively modifying the weights for each of the plurality of decision-making factors and the goal weights for each of the plurality of decision-making goal parameters based on the at least one relationship between the increase and the decrease of the value of the plurality of decision-making goal parameters and the plurality of decision-making factors.

19. The system of claim 18, wherein the weighted comparison module, the processor, and the user device are configured to receive data of a second plurality of decision-making goal parameters.

20. The system of claim 19, wherein the weighted comparison module, the processor, and the user device are configured to stop optimizing the value of the plurality of decision-making goal parameters when the data of the second plurality of decision-making goal parameters is received.
